(19) United States
(12) Patent Application Publication
(10) Pub. No.: US 2014/0160013 A1
(43) Pub. Date: Jun. 12, 2014

(54) SWITCHING DEVICE

(71) Applicant: Pixart Imaging Inc., Hsin-Chu County (TW)

(72) Inventor: TIEN-CHIA LIU, HSIN-CHU COUNTY (TW)

(73) Assignee: Pixart Imaging Inc., Hsin-Chu County (TW)

(21) Appl. No.: 14/090,346

(22) Filed: Nov. 26, 2013

(30) Foreign Application Priority Data
Dec. 10, 2012 (TW) 101146480

(51) Int. Cl. G06F 3/01

(52) U.S. Cl. CPC G06F 3/017
USPC 345/156

(57) ABSTRACT

There is provided a switching device including an image sensor, a processing unit and a transmission unit. The image sensor successively captures image frames. The processing unit is configured to generate a control signal when sequentially recognizing an open hand gesture and a closed fist gesture or sequentially recognizing a closed fist gesture and an open hand gesture according to the image frames within a predetermined time interval. The transmission unit is configured to transmit the control signal to an electronic device.

### CROSS REFERENCE TO RELATED APPLICATION

This application claims the priority benefit of Taiwan Patent Application Serial Number 101146480, filed on Dec. 10, 2012, the full disclosure of which is incorporated herein by reference.

### BACKGROUND

1. Field of the Disclosure

This disclosure generally relates to a switching device and, more particularly, to an optical switching device that may perform the switching operation according to the gesture image change between an open hand gesture and a closed fist gesture of a user.

2. Description of the Related Art

The traditional mechanical switch has the problem of inconvenience in use. For example, it is generally installed at a fixed position and the user has always to directly touch the mechanical switch in order to perform the control. In addition, when the traditional mechanical switch is failed, it is not easy to replace the component.

For improving the use convenience, conventionally it is able to use an infrared light switch to perform the switching operation. For example, when the infrared light switch detects a moving object, a light source is turned on accordingly. However, the infrared light switch starts to operate as long as a moving object is detected, and thus it is not suitable for some conditions.

Conventionally, it is able to use a remote controller as a switching device and a user may perform the corresponding control by pressing the button on the remote controller. However, when the user is desired to perform the switching operation, a remote controller has to be used for performing the control.

Accordingly, the present disclosure further provides an optical switching device that may perform the switching operation according to the gesture change made by a user. Since it is not necessary to use the remote controller as an interface and the optical switching device may be applied to various electronic devices, higher convenience and adaptability may be achieved.

### SUMMARY

The present disclosure provides a switching device that may perform the switching operation according to the gesture image change within a predetermined time interval so as to accordingly control an electronic device.

The present disclosure further provides a switching device that may perform the switching operation according to the image change within a predetermined image range of the image frames so as to accordingly control an electronic device.

The present disclosure provides a switching device including an image sensor, a processing unit and a transmission unit. The image sensor is configured to successively capture image frames. The processing unit is configured to generate a control signal when sequentially recognizing an open hand gesture and a closed fist gesture or sequentially recognizing the closed fist gesture and the open hand gesture according to the image frames within a predetermined time interval. The transmission unit is configured to transmit the control signal to the electronic device for controlling the ON/OFF of the electronic device.

The present disclosure further provides a switching device including an image sensor, a processing unit and a transmission unit. The image sensor is configured to successively capture image frames. The processing unit is configured to identify an object shape and an object area according to the image frames and generate a control signal when the object shape matches a predetermined shape, the object area matches a predetermined area and a predetermined area change occurs within a predetermined time interval. The transmission unit is configured to send the control signal to the electronic device.

The present disclosure further provides an operating method of a switching device including the steps of: successively capturing image frames with an image sensor; recognizing, using a processing unit, an open hand gesture or a closed fist gesture according to the image frames; and generating a control signal when the processing unit recognizes the open hand gesture or the closed fist gesture and recognizes a predetermined gesture change within a predetermined time interval so as to control the ON/OFF of the electronic device.

In one aspect, the processing unit may only process image data of a predetermined image range of the image frames captured by the image sensor within the predetermined time interval so as to save the system resources.

In one aspect, the image sensor may be a far-infrared sensor so as to directly sense the far-infrared energy generated by the human body.

In one aspect, the switching device may further include a red light source, an infrared light source or an invisible light source configured to illuminate a field of view of the image sensor.

In one aspect, the switching device may further include a solar energy module configured to provide electricity for operation, wherein the solar energy module may include a solar panel configured to convert optical energy to electric energy and a battery configured to save the electric energy.

In the switching device and the operating method according to the embodiment of the present disclosure, the predetermined shape may be a circle and an ellipsoid. The predetermined area change may be an area change of 40%-60% or 140%-160% of the object area. The predetermined time interval may be from 0.5 to 2 seconds. The present disclosure is not limited thereto.

In the switching device and the operating method according to the embodiment of the present disclosure, the processing unit may directly recognize the open hand gesture and closed fist gesture within a closer operating range and recognize the object shape and object area within a farther operating range so as to increase the adaptable environment.

### BRIEF DESCRIPTION OF THE DRAWINGS

Other objects, advantages, and novel features of the present disclosure will become more apparent from the following detailed description when taken in conjunction with the accompanying drawings.

FIG. 1 shows a schematic block diagram of the switching device according to an embodiment of the present disclosure.

FIG. 2 shows a schematic block diagram of the switching device according to another embodiment of the present disclosure.

FIG. 3 shows a flow chart of the operating method of the switching device according to an embodiment of the present disclosure.

FIG. 3A shows a schematic diagram of the gesture change of the operating method of the switching device of FIG. 3.

FIG. 4 shows a flow chart of the operating method of the switching device according to another embodiment of the present disclosure.

FIG. 4A shows a schematic diagram of the object area change of the operating method of the switching device of FIG. 4.

FIG. 5 shows a flow chart of the operating method of the switching device according to another embodiment of the present disclosure.

FIG. 6 shows a schematic diagram of the operating method of the switching device according to the embodiment of the present disclosure.

### DETAILED DESCRIPTION OF THE EMBODIMENT

It should be noted that, wherever possible, the same reference numbers will be used throughout the drawings to refer to the same or like parts.

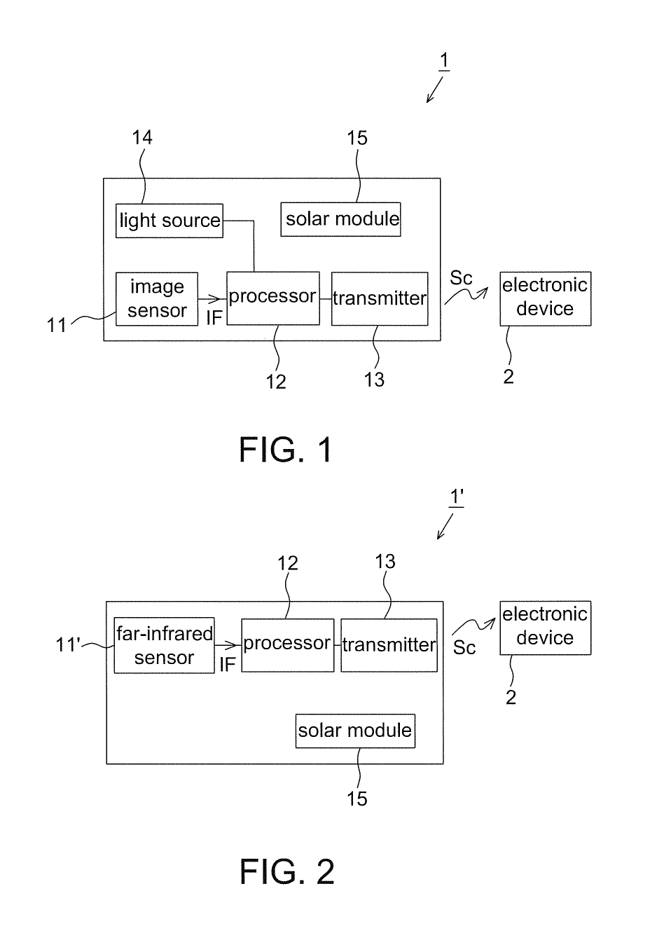

Referring to FIG. 1, it shows a schematic block diagram of the switching device 1 according to an embodiment of the present disclosure, which includes an image sensor 11, a processing unit 12, a transmission unit 13 and a light source 14. The switching device 1 is configured to control an electronic device 2, e.g. the enabling or disabling of a lamp, an automatic door or other home appliances, or to control the electronic device 2 to change the operating parameter, e.g. the operating strength, in steps.

The image sensor 11 may be a CMOS image sensor, a CCD image sensor or other sensors adapted to sense optical energy. The image sensor is configured to successively capture and output image frames IF.

The processing unit 12 may be a digital signal processor (DSP) or other processors configured to process image data. The processing unit 12 is configured to recognize an open hand gesture, a closed fist gesture, an object shape, an object area, a gesture change and an object area change according to the image frames IF, and to generate a control signal Sc when a predetermined rule is matched within a predetermined time interval (described later). In one embodiment, the predetermined time interval may be from 0.5 to 2 seconds, but not limited thereto. For example in other embodiments, the predetermined time interval may be a period that the image sensor 11 (or the far-infrared sensor 11′ shown in FIG. 2) captures a predetermined number of the image frames IF, and the predetermined time interval may be set according to requirements of the user.

The transmission unit 13 may be a wireless transmission unit or a wired transmission unit, and is configured to transmit the control signal Sc to the electronic device 2 so as to perform the corresponding control, wherein wireless and wired communication techniques are well known and thus details thereof are not described herein.

The light source 14 may be a red light source, an infrared light source or other invisible light sources. The light source 14 is configured to illuminate a field of view of the image sensor 11. In this manner, the image sensor 11 may capture image frames IF having a higher image quality.

Referring to FIG. 2, it shows a schematic block diagram of the switching device 1′ according to another embodiment of the present disclosure, which includes a far-infrared sensor 11′, the processing unit 12 and the transmission unit 13. The difference between FIG. 2 and FIG. 1 is that the image sensor 11 of FIG. 1 is replaced by a far-infrared sensor 11′ here. As the switching device 1′ employs the far-infrared sensor 11′, far-infrared energy generated by the human body may be directed sensed even though ambient light is insufficient such that an additional light source is not necessary. In addition, in FIG. 2 functions of the processing unit 12 and the transmission unit 13 are similar to those of FIG. 1 and thus details thereof are not repeated herein.

In addition, the switching devices 1 and 1′ according to the embodiment of the present disclosure may further include a solar energy module 15 configured to provide electricity for operation, wherein the solar energy module 15 may include a solar panel configured to convert optical energy to electric energy and a battery configured to save electricity. Details of the solar energy module are well known and thus are not described herein. In other embodiments, the switching device 1 may also be connected to the commercial power system or powered by other home appliances (e.g. the electronic device 2) and is not limited to employ the solar energy module 15.

In addition, the switching devices 1 and 1′ according to the embodiment of the present disclosure may further include at least one lens or lens set configured to improve the illumination efficiency of the light source 14 and/or the sensing efficiency of the image sensor 11 or the far-infrared sensor 11′.

Referring to FIGS. 1-3, FIG. 3 shows a flow chart of the operating method of the switching device according to an embodiment of the present disclosure, which includes the steps of: capturing image frames (Step S₃₁); recognizing a open hand gesture or a closed fist gesture (Step S₃₂); entering a switch control mode (Step S₃₃); wherein this embodiment may be adapted to a condition that the user is close to the image sensor 11 such that the processing unit 12 may directly recognize the hand shape and the fist shape. In this embodiment, in order to save the system resources, the operating method may further include a Step S₃₄ for selecting a predetermined image range.

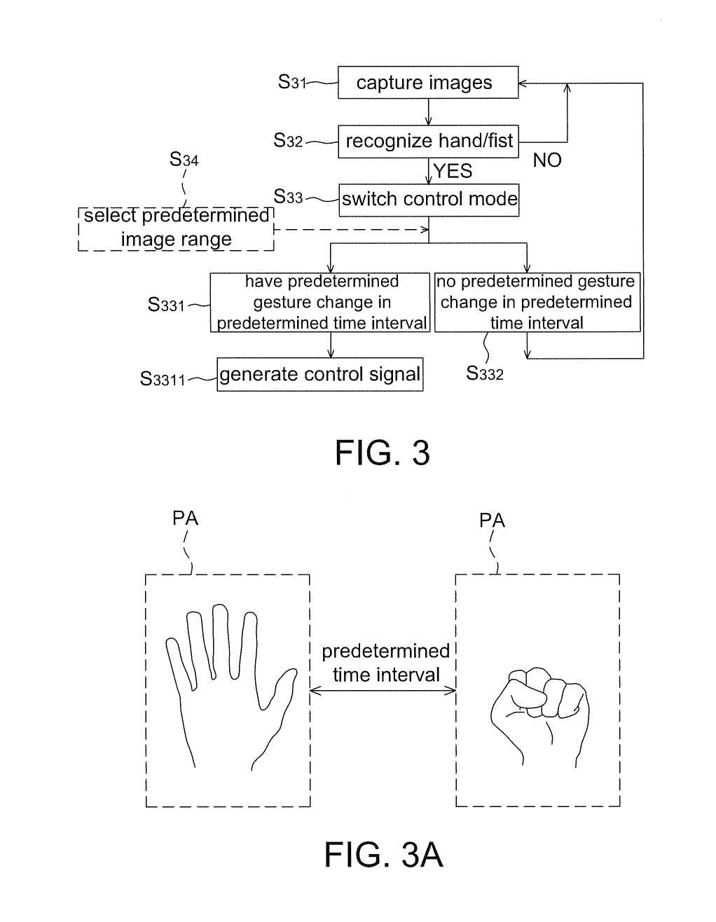

Referring to FIGS. 3, 3A and 6 together, details of this embodiment are described hereinafter.

Step S₃₁: The image sensor 11 (or the far-infrared sensor 11′) may successively capture image frames IF at a fixed or a variable sampling frequency; for example if the object image is not detected for a long time, the processing unit 12 may decrease the sampling frequency (i.e. entering a power saving mode), and a period of said “long time” may be determined according to different applications.

Step S₃₂: The processing unit 12 recognizes an open hand gesture and a closed fist gesture according to the image frames IF; and when the open hand gesture or the closed fist gesture is recognized (e.g. recognizing the open hand gesture or the closed fist gesture in a first image frame IF₁), the switch control mode is entered (Step S₃₃). When the open hand gesture and the closed fist gesture are not recognized, the processing unit 12 recognizes again according to a next image frame IF.

Step S₃₃: In the switch control mode, the processing unit 12 is configured to recognize a predetermined gesture change within a predetermined time interval, wherein the predetermined gesture change may be a change from the open hand gesture to the closed fist gesture or from the closed fist gesture to the open hand gesture (as shown in FIG. 3A). When the processing unit 12 recognizes the predetermined gesture change, e.g. recognizing the closed fist gesture or the open hand gesture in a second image frame IF₁ (Step S₃₃₁), a control signal Sc is generated (Step S₃₃₁₁). However, if the processing unit 12 does not recognize the predetermined gesture change within the predetermined time interval (Step S₃₃₂), the process leaves the switch control mode and returns to the Step S₃₁.

Step S₃₄: As mentioned above, in order to save the system resources, for example when the processing unit 12 recognizes the open hand gesture in a first image frame IF₁, the processing unit 12 recognizes the closed fist gesture only according to a predetermined image range PA in the image frames IF captured after the first image frame IF₁ (as shown in FIG. 3A); or when the processing unit 12 recognizes the closed fist gesture in the first image frame IF₁, the processing unit 12 recognizes the open hand gesture only according to the predetermined image range PA in the image frames IF captured after the first image frame IF₁ (as shown in FIG. 3A). In one embodiment, the processing unit 12 may only process image data of the predetermined image range PA of the image frames IF captured by the image sensor 11 (or the far-infrared sensor 11′) within the predetermined time interval. In another embodiment, the processing unit 12 may also process image data of the whole image frame IF, but only the image data of the predetermined image range PA is served as valid image data whereas the image data outside the predetermined image range PA is served as the reference for other functions. The predetermined image range PA may be previously set according to an operable range of the switching devices 1 and 1′ or may be selected by the user. In addition, the Step S₃₄ may not be implemented.

In a word, in this embodiment the processing unit 12 is configured to generate a control signal Sc when sequentially recognizing an open hand gesture and a closed fist gesture or sequentially recognizing the closed fist gesture and the open hand gesture according to the image frames IF within a predetermined time interval as shown in FIG. 6 so as to correspondingly control the electronic device 2.

Referring to FIGS. 1, 2 and 4, FIG. 4 shows a flow chart of the operating method of the switching device according to another embodiment of the present disclosure, which includes the steps of: capturing image frames (Step S₄₁); identifying an object shape (Step S₄₂); identifying an object area (Step S₄₃); when the object shape matches a predetermined shape and the object area matches a predetermined area, entering a switch control mode of Step S₄₅; whereas when the object shape mismatches a predetermined shape or the object area mismatches a predetermined area, returning to the Step S₄₁ (Step S₄₄), wherein this embodiment may be adapted to a condition that the user is far from the image sensor 11 (or the far-infrared sensor 11′) such that the processing unit 12 can not clearly recognize the hand shape or the fist shape but can only recognize the object outline and area. However, this embodiment may also be adapted to the condition that the hand shape and the fist shape can be clearly recognized. Similarly, in order to save the system resources, the operating method may further include a Step S₄₆ for selecting a predetermined image range.

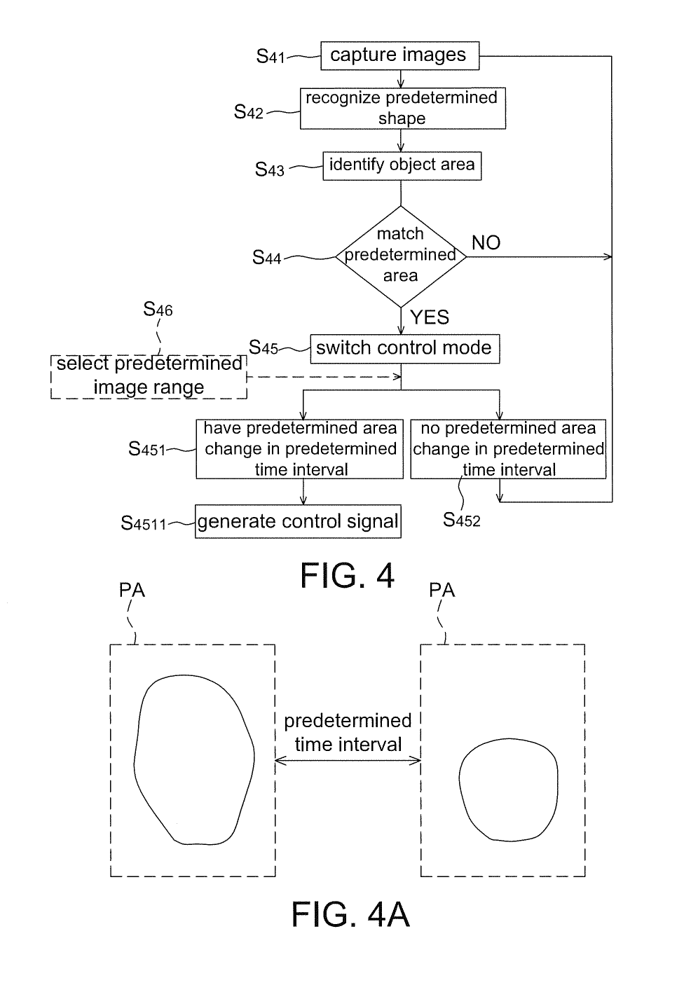

Referring to FIGS. 4, 4A and 6 together, details of this embodiment are described hereinafter.

Step S₄₁: Similar to the Step S₃₁, the image sensor 11 (or the far-infrared sensor 11′) may successively capture image frames IF at a fixed or a variable sampling frequency.

Step S₄₂: The processing unit 12 identifies whether an object shape matches a predetermined shape according to the image frames IF. For example when the user is far from the image sensor 11 or the image sensor 11 has a low resolution, an outline of the open hand gesture is similar to an ellipsoid and an outline of the closed fist gesture is similar to a circle (as shown in FIG. 4A). Therefore, only when the processing unit 12 identifies that an object image matches an ellipsoid or a circle, the processing unit 12 starts to identify the object area thereof. In addition, in order to eliminate the background object, the processing unit 12 may previously recognize and remove the object at a fixed position and having a shape of ellipsoid or circle.

Step S₄₃: Next, the processing unit 12 identifies whether an object area matches a predetermined area (or an area range) according to the image frames IF so as to eliminate the object not corresponding to the gesture of the user, wherein the predetermined area may be previously set according to the operating environment of the switching devices 1 and 1′. For example within an operable rage of 5 meters, areas associated with the open hand gesture and the closed fist gesture may be previously measured and saved in the switching devices 1 and 1′. The processing unit 12 may remove the object image falling out the predetermined area or the predetermined area range so as to increase the identification accuracy. For example, a head image of a user may not fall into a range of the predetermined area such that the processing unit 12 may remove the head image.

Step S₄₄: When the processing unit 12 identifies that the object shape matches a predetermined shape and the object area matches a predetermined area, the switch control mode is entered (Step S₄₅); or returning to the Step S₄₁.

Step S₄₅: In the switch control mode, the processing unit 12 is configured to recognize a predetermined area change within a predetermined time interval, wherein the predetermined area change may be an area change, as shown in FIG. 4A, of 40%-60% (e.g. from open hand to fist) or 140%-160% (e.g. from fist to open hand) of the object area recognized in the Step S₄₃. When the processing unit 12 recognizes the predetermined area change within the predetermined time interval (Step S₄₅₁), a control signal Sc is generated (Step S₄₅₁₁). However, when the processing unit 12 does not recognize the predetermined area change within the predetermined time interval (Step S₄₅2), the process leaves the switch control mode and returns to the Step S₄₁. For example, FIG. 6 shows that the processing unit 12 identifies that the object shape in a first image frame IF₁ matches a predetermined shape and the object area in the first image frame IF₁ matches a predetermined area, and recognizes the predetermined area change in a second image frame IF₂.

Step S₄₆: As mentioned above, in order to save the system resources, for example when the processing unit 12 recognizes that the object shape matches a predetermined shape and the object area matches a predetermined area in a first image frame IF₁, the processing unit 12 recognizes the predetermined area change only according to a predetermined image range PA in the image frames IF captured after the first image frame IF₁. Similarly, in one embodiment the processing unit 12 may only process image data of the predetermined image range PA of the image frames IF captured by the image sensor 11 within the predetermined time interval. In another embodiment, the processing unit 12 may also process image data of the whole image frame IF, but only the image data of the predetermined image range PA is served as valid image data whereas the image data outside the predetermined image range PA is served as the reference for other functions. Similarly, the Step S₄₆ may not be implemented.

In a word, in this embodiment the processing unit 12 is configured to identify an object shape and an object area according to the image frames IF and generate a control signal Sc when the object shape matches a predetermined shape and the object area matches a predetermined area and a predetermined area change occurs within a predetermined time interval as shown in FIG. 6 so as to correspondingly control the electronic device 2.

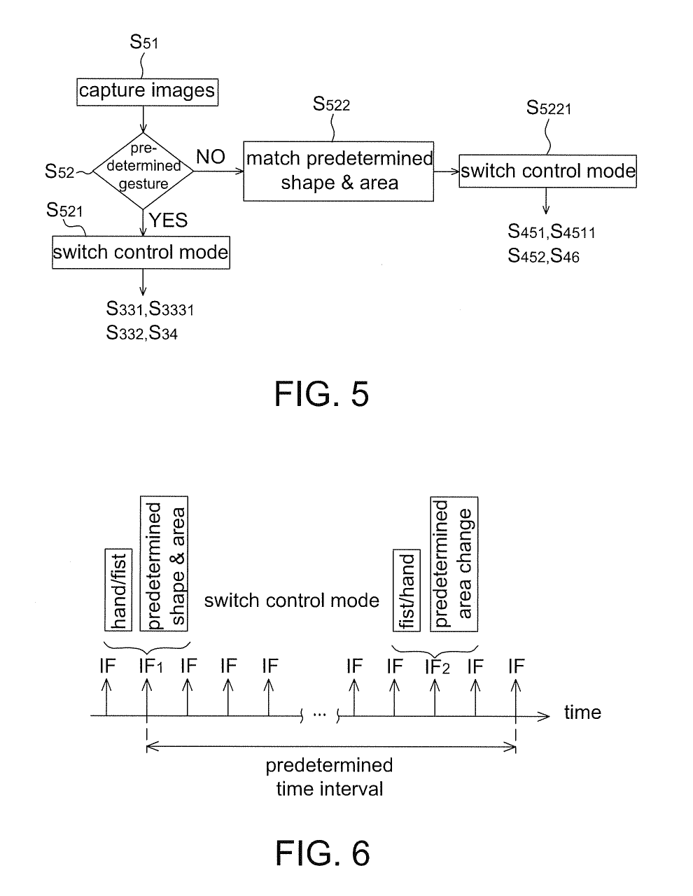

Referring to FIG. 5, it shows a flow chart of the operating method of the switching device according to another embodiment of the present disclosure. In this embodiment, in order to increase the adaptability of the switching devices 1 and 1′, the processing unit 12 may simultaneously perform the steps of FIGS. 3 and 4; i.e. when the processing unit 12 may clearly recognize the hand shape and the fist shape, the embodiment of FIG. 3 is executed whereas when the hand shape and the fist shape can not be clearly recognized, the embodiment of FIG. 4 is executed. In this manner, the witching devices 1 and 1′ may be adapted to both operations in far range and close range.

This embodiment includes the following steps: capturing image frames (Step S₅₁); identifying a predetermined gesture (Step S₅₂); directly entering a switch control mode when the predetermined gesture is recognized (Step S₅₂₁); recognizing an object shape and an object area when the predetermined gesture is not recognized (Step S₅₂₂); and entering the switch control mode when the object shape matches a predetermined shape and the object area matches a predetermined area (Step S₅₂₂₁), wherein when the predetermined gesture is not recognized and the object shape does not match a predetermined shape and the object area does not match a predetermined area, return to the Step S₅₁ and capture a new image frame IF.

Referring to FIGS. 3, 3A, 4, 4A, 5 and 6 together, details of this embodiment are described hereinafter.

Step S₅₁: Similar to the Step S₃₁ and Step S₄₁, the image sensor 11 (or the far-infrared sensor 11′) may successively capture image frames IF at a fixed or a variable sampling frequency.

Step S₅₂: The processing unit 12 recognizes a predetermined gesture according to the image frames IF, wherein the predetermined gesture may be an open hand gesture or a closed fist gesture (as shown in FIG. 3A), and when the predetermined gesture is recognized, the switch control mode is entered (Step S₅₂₁). In this embodiment, after entering the switch control mode (Step S₅₂₁), the Steps S₃₃₁ and S₃₃₁₁ or the Step S₃₃₂ of FIG. 3 is executed, and the Step S₃₄ may or may not be executed, wherein details of the Steps S₃₃₁, S₃₃₁₁, S₃₃₂ and the Step S₃₄ have been described above and thus are not repeated herein.

Step S₅₂₂: When the processing unit 12 does not recognize the predetermined gesture, the processing unit 12 identifies an object shape and an object area according to the image frames IF, and when the object shape matches a predetermined shape and the object area matches a predetermined area, the switch control mode is entered (Step S₅₂₂₁). In this embodiment, after entering the switch control mode (Step S₅₂₂₁), the Steps S₄₅₁ and S₄₅₁₁ or the Step S₄₅₂ of FIG. 4 is executed, and the Step S₄₆ may or may not be executed, wherein details of the Steps S₄₅₁, S₄₅₁₁, S₄₅₂ and the Step S₄₆ have been described above and thus are not repeated herein for simplification. For example, each time the processing unit 12 receives an image frame IF, the processing unit 12 may firstly recognize the predetermined gesture, and if the predetermined gesture can not be recognized then recognizes the object shape and the object area.

It should be mentioned that the method of recognizing the open hand gesture or the closed fist gesture by the processing unit 12 may be performed according to the object shape in the image frame IF. For recognizing the object shape and the object area in the image frame IF by the processing unit 12, for example at least one brightness threshold may be set and the object shape and the object area may be determined according to the arrangement of pixels in the image frame IF having the brightness value larger than the brightness threshold. The operating methods of the switching device of FIGS. 3-5 may be applied to both the switching devices 1 and 1′ of FIGS. 1 and 2.

As mentioned above, the conventional switching device has the problem of inconvenience in use and not adaptable to particular conditions. Therefore, the present disclosure further provides a switching device (FIGS. 1 and 2) and the operating method thereof (FIGS. 3 to 6) that may directly perform the switching operation according to the image change of an open hand gesture or a closed fist gesture made by a user, and the ambient object may be eliminated so as to avoid misoperation.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A switching device, configured to control an electronic device, the switching device comprising:
an image sensor configured to successively capture image frames;
a processing unit configured to generate a control signal when sequentially recognizing an open hand gesture and a closed fist gesture or sequentially recognizing the closed fist gesture and the open hand gesture according to the image frames within a predetermined time interval; and
a transmission unit configured to transmit the control signal to the electronic device.

2. The switching device as claimed in claim 1, wherein when recognizing the open hand gesture in a first image frame, the processing unit recognizes the closed fist gesture only according to a predetermined image range of the image frames captured after the first image frame; or when recognizing the closed fist gesture in the first image frame, the processing unit recognizes the open hand gesture only according to the predetermined image range of the image frames captured after the first image frame.

3. The switching device as claimed in claim 2, wherein the processing unit only processes image data of the predetermined image range within the predetermined time interval.

4. The switching device as claimed in claim 1, wherein the image sensor is a far-infrared sensor.

5. The switching device as claimed in claim 1, further comprising an infrared light source configured to illuminate a field of view of the image sensor.

6. The switching device as claimed in claim 1, further comprising a solar energy module configured to provide electricity for operation.

7. The switching device as claimed in claim 1, wherein the predetermined time interval is from 0.5 to 2 seconds.

8. A switching device, configured to control an electronic device, the switching device comprising:
an image sensor configured to successively capture image frames;
a processing unit configured to identify an object shape and an object area according to the image frames and generate a control signal when the object shape matches a predetermined shape, the object area matches a predetermined area and a predetermined area change occurs within a predetermined time interval; and
a transmission unit configured to transmit the control signal to the electronic device.

9. The switching device as claimed in claim 8, wherein when the object shape in a first image frame matches the predetermined shape and the object area in the first image frame matches the predetermined area, the processing unit recognizes the predetermined area change only according to a predetermined image range of the image frames captured after the first image frame.

10. The switching device as claimed in claim 9, wherein the processing unit only processes image data of the predetermined image range within the predetermined time interval.

11. The switching device as claimed in claim 8, wherein the image sensor is a far-infrared sensor.

12. The switching device as claimed in claim 8, further comprising an infrared light source configured to illuminate a field of view of the image sensor.

13. The switching device as claimed in claim 8, further comprising a solar energy module configured to provide electricity for operation.

14. The switching device as claimed in claim 8, wherein the predetermined shape is a circle and an ellipsoid.

15. The switching device as claimed in claim 8, wherein the predetermined area change is an area change of 40%-60% or 140%-160% of the object area.

16. The switching device as claimed in claim 8, wherein the predetermined time interval is from 0.5 to 2 seconds.

17. An operating method of a switching device, the switching device comprising an image sensor and a processing unit, the operating method comprising:
successively capturing image frames with the image sensor;
recognizing, using the processing unit, an open hand gesture or a closed fist gesture according to the image frames; and
generating a control signal when the processing unit recognizes the open hand gesture or the closed fist gesture and recognizes a predetermined gesture change within a predetermined time interval.

18. The operating method as claimed in claim 17, wherein the predetermined gesture change is a change from the open hand gesture to the closed fist gesture or from the closed fist gesture to the open hand gesture.

19. The operating method as claimed in claim 17, further comprising:
only processing, using the processing unit, image data of a predetermined image range of the image frames captured by the image sensor within the predetermined time interval when recognizing the open hand gesture or the closed fist gesture in a first image frame.

20. The operating method as claimed in claim 17, wherein when the open hand gesture and the closed fist gesture are not recognized, the operating method further comprises:
identifying, using the processing unit, an object shape and an object area according to the image frames; and
generating the control signal when the object shape matches a predetermined shape, the object area matches a predetermined area and a predetermined area change occurs within the predetermined time interval.
